(19) United States
(12) Patent Application Publication
(10) Pub. No.: US 2024/0096523 A1
(43) Pub. Date: Mar. 21, 2024

(54) Method for manufacturing an electrical cable having improved thermal conductivity

(71) Applicant: NEXANS, Courbevoie (FR)

(72) Inventors: Gabriele PEREGO, MILAN (IT); Christelle MAZEL, RUY (FR); Daphné MERLE, VENISSIEUX (FR)

(21) Appl. No.: 18/267,776

(22) PCT Filed: Dec. 8, 2021
(86) PCT No.: PCT/FR2021/052243

§ 371 Date: Jun. 15, 2023

(30) Foreign Application Priority Data
Dec. 18, 2020 (FR) FR2013622

(51) Int. Cl. H01B 13/24; H01B 3/20; H01B 3/44

(52) U.S. Cl. CPC H01B 13/24; H01B 3/20; H01B 3/441

(57) ABSTRACT

The invention relates to a process for manufacturing a cable comprising at least one electrically insulating layer obtained from a polymer composition comprising at least one polypropylene-based thermoplastic polymer material, at least one dielectric liquid, and at least one thermally conductive inorganic filler, said process involving the mixing of the thermally conductive inorganic filler with the dielectric liquid to form a filler-charged dielectric liquid prior to placing the dielectric liquid in contact with said thermoplastic polymer material.

The invention relates to a process for manufacturing a cable comprising at least one electrically insulating layer obtained from a polymer composition comprising at least one polypropylene-based thermoplastic polymer material, at least one dielectric liquid, and at least one thermally conductive inorganic filler, said process involving the mixing of the thermally conductive inorganic filler with the dielectric liquid to form a filler-charged dielectric liquid before placing the dielectric liquid in contact with said polymer material.

The invention typically but not exclusively applies to electric cables intended for power transmission, notably to medium-voltage power cables (notably from 6 to 45-60 kV), whether in direct or alternating current, in the fields of aerial, submarine or terrestrial power transmission, or else in aeronautics.

The invention applies in particular to electric cables with improved thermal conductivity.

A medium-voltage power transmission cable preferably comprises, from the inside to the outside:
an elongated electrically conductive element, notably made of copper or aluminum;
an inner semiconductive layer surrounding said elongated electrically conductive element;
an electrically insulating layer surrounding said inner semiconductive layer;
an outer semiconductive layer surrounding said insulating layer;
optionally an electrical shield surrounding said outer semiconductive layer; and
optionally an electrically insulating protective sheath surrounding said electrical shield.

International patent application WO 2019/072388 A1 discloses a cable comprising an electrically insulating layer obtained from a polymer composition comprising at least one polypropylene-based thermoplastic polymer material and boron nitride having a particle size distribution D50 of not more than 15 μm. More particularly, the electrically insulating layer is made by impregnating the dielectric liquid into the polymeric material so as to obtain granules of polymer material impregnated with said dielectric liquid, mixing the granules with a boron nitride powder having a particle size distribution D50 of not more than 15 μm so as to form a polymer composition, and then extruding the polymer composition around the cable core.

However, the thermal conductivity properties of the electrically insulating layer thus obtained are not optimized. Moreover, the incorporation of boron nitride or other inorganic fillers into a polymer material is generally difficult to perform due to the presence and/or formation of agglomerates, which occasionally makes the process long and/or requires special equipment that increases the production cost of the cable.

The aim of the present invention is consequently to overcome the drawbacks of the techniques of the prior art by proposing a process for manufacturing an electric cable, notably a medium-voltage cable, based on propylene polymer(s), said process being easy to perform, inexpensive, not requiring complex equipment, and being able to produce a cable which can operate at temperatures above 70° C., and having improved thermal conductivity properties, while at the same time ensuring good electrical properties, notably in terms of dielectric strength.

The aim is achieved by the invention which will be described hereinbelow.

A first subject of the invention is a process for manufacturing an electric cable comprising at least one elongated electrically conductive element and at least one electrically insulating layer obtained from a polymer composition comprising at least one polypropylene-based thermoplastic polymer material, at least one dielectric liquid, and at least one thermally conductive inorganic filler, said process being characterized in that it comprises at least the following steps:
i) mixing the dielectric liquid with the thermally conductive inorganic filler, to form a filler-charged dielectric liquid,
ii) mixing the filler-charged dielectric liquid with the thermoplastic polymer material to form a polymer composition, and
iii) extruding the polymer composition around the elongated electrically conductive element.

The process of the invention is simple to perform, inexpensive, and does not require any complex equipment. Moreover, it produces a cable that can operate at temperatures above 70° C., and which has improved thermal conductivity properties, while at the same time ensuring good electrical properties.

The dispersion of the thermally conductive inorganic filler in the dielectric liquid during step i), before being placed in contact with the thermoplastic polymer material according to step ii), makes it possible to promote the dispersion of the thermally conductive inorganic filler within the polymer material, and to improve the thermal conductivity of the layer thus obtained.

Step i)

Step i) involves mixing the dielectric liquid with the inorganic filler.

This step i) may be performed at a temperature ranging from about 0° C. to about 100° C., and preferably from about 20° C. to about 80° C. Step i) is generally performed at room temperature (i.e. from about 15° C. to about 35° C.).

Step i) is advantageously performed with a mixer suitable for mixing a powder into a liquid, for instance a turbomixer, a planetary mixer, a tubular continuous mixing device, and/or an ultrasonic device.

Turbomixers are high-speed cylindrical mechanical mixers, usually having at least one mixing tool (e.g. blade). They have the distinctive feature of generally operating at high rotational speeds, which will depend on their size. Commonly used peripheral speeds range from 20 to 50 m/sec or speeds of 1800 to 2250 rpm.

An example of a planetary mixer may be a speed mixer. This type of mixer is based on a double rotation of a bowl (instead of blade(s)), with high rotational speeds, for instance ranging from 1800 to 2250 rpm. The combination of centrifugal forces without the presence of a mixing tool (e.g. blade) acts on several levels and results in very fast mixing without air bubbles. A suitable mixer is, for example, the speed mixer sold under the trade name Speedmixer DAC 400 FV.

This step i) may last from about 5 min to about 10 hours, and preferably from about 1 hour to about 5 hours.

The Thermally Conductive Inorganic Filler

On conclusion of step i), the thermally conductive inorganic filler may represent from about 10% to about 75% by weight, preferably from about 20% to about 70% by weight, and particularly preferably from about 30% to about 60% by weight relative to the total weight of the filler-charged dielectric liquid (i.e. the dielectric liquid and the thermally conductive inorganic filler). Above 75% of thermally conductive inorganic filler in the filler-charged dielectric liquid, the thermally conductive inorganic filler penetrates the dielectric liquid with greater difficulty.

The thermally conductive inorganic filler may have a thermal conductivity of at least about 1 W/m·k at 20° C., and preferably of at least about 5 W/m·k at 20° C.

In the present invention, the thermal conductivity is preferably measured according to the well-known Transient Plane Source or TPS method. Advantageously, the thermal conductivity is measured using a device sold under the reference Hot Disk TPS 2500S by the company Thermoconcept.

The thermally conductive inorganic filler may be chosen from silicates, boron nitride, carbonates, metal oxides, and a mixture thereof, and preferably from silicates, carbonates, metal oxides, and a mixture thereof.

A mixture of the thermally conductive inorganic fillers is preferably a mixture of two or three of said thermally conductive inorganic fillers.

Among the silicates, mention may be made of aluminum, calcium, or magnesium silicates.

Aluminum silicates are preferred.

The aluminum silicates may be chosen from kaolins and any other mineral or clay predominantly comprising kaolinite.

In the present invention, the term “any other mineral or clay predominantly comprising kaolinite” means any other mineral or clay comprising at least about 50% by weight, preferably at least about 60% by weight, and more preferably at least about 70% by weight, of kaolinite, relative to the total weight of the mineral or clay.

Kaolins, in particular calcined kaolin, are preferred.

Among the carbonates, mention may be made of chalk, calcium carbonate (e.g. aragonite, vaterite, calcite, or a mixture of at least two of the abovementioned compounds), magnesium carbonate, limestone, or any other mineral predominantly comprising calcium carbonate or magnesium carbonate.

In the present invention, the term “any other mineral predominantly comprising calcium carbonate or magnesium carbonate” means any other mineral comprising at least about 50% by weight, preferably at least about 60% by weight, and more preferably at least about 70% by weight, of calcium carbonate or magnesium carbonate, relative to the total weight of the mineral.

Chalk and calcium carbonate are preferred.

Among the metal oxides, mention may be made of aluminum oxide, a hydrated aluminum oxide, magnesium oxide, silicon dioxide, or zinc oxide.

In the present invention, aluminum oxide, also well known as alumina, is a chemical compound having the formula Al₂O₃.

The hydrated aluminum oxide or hydrated alumina may be an aluminum oxide monohydrate or polyhydrate, and preferably monohydrate or trihydrate.

As examples of aluminum oxide monohydrates, mention may be made of boehmite, which is the gamma polymorph of AlO(OH) or Al₂O₃·H₂O; or diaspore, which is the alpha polymorph of AlO(OH) or Al₂O₃·H₂O.

As examples of aluminum oxide polyhydrates, and preferably trihydrates, mention may be made of gibbsite or hydrargillite, which is the gamma polymorph of Al(OH)₃; bayerite, which is the alpha polymorph of Al(OH)₃; or nordstrandite, which is the beta polymorph of Al(OH)₃.

Hydrated aluminum oxide is also well known as “aluminum oxide hydroxide” or “alumina hydroxide”.

Aluminum oxide, magnesium oxide, and silicon dioxide are preferred.

The aluminum oxide (or, respectively, magnesium oxide) is preferably a calcined aluminum oxide (or, respectively, a calcined magnesium oxide).

The silicon dioxide is preferably fumed silica.

According to a particularly preferred embodiment of the invention, the thermally conductive inorganic filler is chosen from kaolins, chalk, a calcined magnesium oxide, fumed silica, and a calcined aluminum oxide.

The thermally conductive inorganic filler may be in the form of particles ranging in size from about 0.001 to about 6 μm, preferably from about 0.02 to about 2 μm, particularly preferably from about 0.050 to about 1.5 μm, and more particularly preferably from about 0.075 to about 1.0 μm.

According to a particularly preferred embodiment, the thermally conductive inorganic filler is in the form of nanometric particles, for instance particles having at least one of their dimensions ranging from about 1 to about 800 nm, preferably ranging from about 1 to about 500 nm, and particularly preferably ranging from about 1 to 250 nm.

The use of nanometric thermally conductive inorganic filler particles improves the thermal conductivity of the polymer composition.

Considering several thermally conductive inorganic filler particles according to the invention, the term “size” represents the size distribution D50, this distribution being conventionally determined by methods that are well known to those skilled in the art.

The size of the thermally conductive particle(s) according to the invention may be determined, for example, by microscopy, notably by scanning electron microscopy (SEM), by transmission electron microscopy (TEM), or by laser diffraction.

The size distribution D50 is preferably measured by laser diffraction, for example using a laser beam diffraction granulometer. The size distribution D50 indicates that 50% by volume of the particle population has an equivalent sphere diameter less than the given value.

The thermally conductive inorganic filler may be “treated” or “untreated”, and preferably “treated”.

The term “treated thermally conductive inorganic filler” means a thermally conductive inorganic filler that has undergone surface treatment, or in other words, a surface-treated thermally conductive inorganic filler. Said surface treatment notably modifies the surface properties of the thermally conductive inorganic filler, for example to improve the compatibility of the thermally conductive inorganic filler with the thermoplastic polymer material.

In a preferred embodiment, the thermally conductive inorganic filler of the invention is silanized, or in other words is treated to obtain a silanized thermally conductive inorganic filler.

The surface treatment used to obtain the silanized thermally conductive inorganic filler may be a surface treatment using at least one silane compound (with or without a coupling agent), this type of surface treatment being well known to those skilled in the art.

Thus, the silanized thermally conductive inorganic filler of the invention may comprise siloxane and/or silane groups on its surface. Said groups may be of the vinylsilane, alkylsilane, epoxysilane, methacryloxysilane, acryloxysilane, am inosilane or mercaptosilane type.

The silane compound used for obtaining the silanized thermally conductive inorganic filler may be chosen from:
alkyltrimethoxysilane or alkyltriethoxysilane, for instance octadecyltrimethoxysilane (OdTMS-C18), octyl(triethoxy)silane (OTES-C8), methyltrimethoxysilane, hexadecyltrimethoxysilane,
vinyltrimethoxysilane or vinyltriethoxysilane,
methacryloxylsilane or acryloxysilane, for instance 3-methacryloxypropylmethyldimethoxysilane, 3-methacryloxypropyltrimethoxysilane, 3-methacryloxypropyltrimethoxysilane, 3-acryloxypropyltrimethoxysilane, and
a mixture thereof.

The thermally conductive inorganic filler may have a specific surface area according to the BET method ranging from about 1 to about 1000 m²/g, preferably from about 10 to about 750 cm²/g, and particularly preferably from about 50 to about 500 m²/g.

In the present invention, the specific surface area of the thermally conductive inorganic filler may be readily determined according to the standard DIN 9277 (2010).

The Dielectric Liquid

The dielectric liquid of step i) may comprise at least one liquid chosen from a mineral oil (e.g. naphthenic oil, paraffinic oil or aromatic oil), a plant oil (e.g. soybean oil, linseed oil, rapeseed oil, corn oil or castor oil), a synthetic oil such as an aromatic hydrocarbon (alkylbenzene, alkylnaphthalene, alkylbiphenyl, alkyldiarylethylene, etc.), a silicone oil, an ether oxide, an organic ester, and an aliphatic hydrocarbon, and preferably from a mineral oil (e.g. naphthenic oil, paraffinic oil or aromatic oil), a plant oil (e.g. soybean oil, linseed oil, rapeseed oil, corn oil or castor oil), a synthetic oil such as an aromatic hydrocarbon (alkylbenzene, alkylnaphthalene, alkylbiphenyl, alkyldiarylethylene, etc.), a silicone oil, and an aliphatic hydrocarbon.

The liquid component of the dielectric liquid is generally liquid at about 20-25° C.

The dielectric liquid may comprise at least about 70% by weight of the liquid component of the dielectric liquid, preferably at least about 80% by weight, and particularly preferably at least about 90% by weight of the liquid component of the dielectric liquid, relative to the total weight of the dielectric liquid.

Mineral oil is preferred as a liquid component of the dielectric liquid.

The dielectric liquid particularly preferably comprises at least one mineral oil, and at least one polar compound of the benzophenone or acetophenone type, or a derivative thereof.

The mineral oil is preferably chosen from naphthenic oils and paraffinic oils.

The mineral oil is obtained from the refining of a petroleum crude oil.

According to a particularly preferred embodiment of the invention, the mineral oil comprises a paraffinic carbon (Cp) content ranging from about 45 at % to about 65 at %, a naphthenic carbon (Cn) content ranging from about 35 at % to about 55 at %, and an aromatic carbon (Ca) content ranging from about 0.5 at % to about 10 at %.

In a particular embodiment, the polar compound such as benzophenone, acetophenone or a derivative thereof represents at least about 2.5% by weight, preferably at least about 3.5% by weight, and particularly preferably at least about 4% by weight, relative to the total weight of the dielectric liquid. The polar compound can improve the dielectric strength of the electrically insulating layer.

The dielectric liquid may comprise not more than about 30% by weight, preferably not more than about 20% by weight, and even more preferentially not more than about 15% by weight, of a polar compound of the benzophenone or acetophenone type or a derivative thereof, relative to the total weight of the dielectric liquid. This maximum amount ensures moderate or even low dielectric losses (e.g. less than about 10⁻³), and also prevents migration of the dielectric liquid out of the electrically insulating layer.

According to a preferred embodiment of the invention, the polar compound such as benzophenone, acetophenone or a derivative thereof is chosen from benzophenone, dibenzosuberone, fluorenone and anthrone. Benzophenone is particularly preferred.

One or more additives may form part of the constituents of the dielectric liquid, the filler-charged dielectric liquid, or the polymer composition.

The additives may be chosen from processing aids such as lubricants, compatibilizers, coupling agents, antioxidants, UV stabilizers, antioxidants, anti-copper agents, water-tree-reducing agents, pigments, and a mixture thereof.

The antioxidants are used for protecting the polymer composition from thermal stresses generated during the steps of manufacturing the cable or when the cable is operating.

The antioxidants are preferably chosen from hindered phenols, thioesters, sulfur-based antioxidants, phosphorus-based antioxidants, amine-type antioxidants, and a mixture thereof.

As examples of hindered phenols, mention may be made of 1,2-bis(3,5-di-tert-butyl-4-hydroxyhydrocinnamoyl)hydrazine (Irganox® MD 1024), pentaerythrityl tetrakis(3-(3,5-di-tert-butyl-4-hydroxyphenyl)propionate (Irganox® 1010), octadecyl 3-(3,5-di-tert-butyl-4-hydroxyphenyl)propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thiobis(6-tert-butyl-4-methylphenol) (Irganox® 1081), 2,2′-thiodiethylenebis[3-(3,5-di-tert-butyl-4-hydroxyphenyl) propionate] (Irganox® 1035) tris(3,5-di-tert-butyl-4-hydroxybenzyl) isocyanurate (Irganox® 3114), 2,2′-oxamidobis(ethyl-3(3,5-di-tert-butyl-4-hydroxyphenyl)propionate) (Naugard XL-1), or 2,2′-methylenebis(6-tert-butyl-4-methylphenol).

As examples of sulfur-based antioxidants, mention may be made of thioethers such as didodecyl 3,3′-thiodipropionate (Irganox® PS800), distearyl thiodipropionate or dioctadecyl 3,3′-thiodipropionate (Irganox® PS802), bis[2-methyl-4-{3-n-(C₁₂ or C₁₄)alkylthiopropionyloxy}-5-tert-butylphenyl] sulfide, thiobis[2-tert-butyl-5-methyl-4,1-phenylene] bis[3-(dodecylthio)propionate], or 4,6-bis(octylthiomethyl)-o-cresol (Irganox® 1520 or Irgastab® KV10).

As examples of phosphorus-based antioxidants, mention may be made of tris(2,4-di-tert-butylphenyl) phosphite (Irgafos® 168) or bis(2,4-di-tert-butylphenyl)pentaerythrityl diphosphite (Ultranox® 626).

As examples of antioxidants of amine type, mention may be made of phenylenediamines (e.g. para-phenylenediamines such as 1PPD or 6PPD), diphenylaminestyrenes, diphenylamines, or 4-(1-methyl-1-phenylethyl)-N-[4-(1-methyl-1-phenylethyl)phenyl]aniline (Naugard 445), mercaptobenzimidazoles, or polymerized 2,2,4-trimethyl-1,2-dihydroquinoline (TMQ).

As examples of antioxidant mixtures that may be used according to the invention, mention may be made of Irganox B 225 which comprises an equimolar mixture of Irgafos 168 and Irganox 1010 as described above.

The antioxidant may represent from about 3% to about 25% by weight, and preferably from about 5% to about 20% by weight, relative to the total weight of the dielectric liquid.

On conclusion of step i), the dielectric liquid may represent from about 25% to about 90% by weight, preferably from about 30% to about 80% by weight, and particularly preferably from about 40% to about 70% by weight, relative to the total weight of the filler-charged dielectric liquid (i.e. the dielectric liquid and the thermally conductive inorganic filler).

Step i₀)

The process may also comprise, prior to step i), a step i₀) of preparing the dielectric liquid.

In step i₀), the dielectric liquid may be prepared by mixing the various constituents of the dielectric liquid.

Step i₀) may then be performed by mixing the mineral oil with the polar compound.

Step i₀) may be performed at a temperature ranging from about 20° C. to about 100° C., notably so as to ensure homogeneous mixing of the mineral oil with the polar compound.

One or more of the additives as defined in the invention may be added during step i₀), i) or ii).

When the additive is an antioxidant, it is preferentially added in step i₀).

In other words, step i₀) involves mixing the liquid component of the dielectric liquid, and optionally the polar compound, with at least one antioxidant.

When the antioxidant is present, step i₀) involves mixing the mineral oil with optionally the polar compound, and with the antioxidant.

Step i₀) is optional. In other words, the various constituents of the dielectric liquid may be mixed with the thermally conductive inorganic filler without the prior step i₀).

Step ii)

Step ii) involves mixing the filler-charged dielectric liquid obtained in step i) with the thermoplastic polymer material, to form the polymer composition.

This step places the filler-charged dielectric liquid, optionally comprising one or more additives, in contact with the thermoplastic polymer material.

Step ii) is preferably performed at a temperature of from about 170° C. to about 240° C., and particularly preferably from about 180° C. to about 220° C.

According to a particular embodiment, in step ii), the polypropylene-based thermoplastic polymer material is used in an amount such that it represents from about 75% to 97% by weight, and preferably from about 80% to 95% by weight, relative to the total weight of the polymer composition.

Step ii) is preferably performed using an extruder or an internal mixer, and preferably an extruder.

The extruder preferably comprises a screw.

According to one embodiment of the invention, the extruder used in step ii) of the process of the invention is a single-screw extruder. It thus comprises a single screw.

The extruder may be equipped with at least one feed hopper connected to the extruder and configured to introduce or inject components into the extruder.

According to a particularly preferred embodiment of the invention, step ii) is performed according to the following substeps:
ii-1) introducing the filler-charged dielectric liquid [from step i)] into an extruder by means of a feed hopper,
ii-2) introducing the thermoplastic polymer material, notably in the form of granules, into the extruder by means of the feed hopper,
ii-3) mixing the filler-charged dielectric liquid and the thermoplastic polymer material in the extruder so as to form the polymer composition, and
ii-4) melting the thermoplastic polymer material.

In step ii), the filler-charged dielectric liquid and the thermoplastic polymer material are preferably fed into a first zone of the screw, referred to as the feed zone (substeps ii-1 and ii-2)).

The feed zone or first screw zone is notably located at the inlet of the extruder.

The resulting mixture may then be fed from the feed zone to one or more intermediate zones of the screw allowing the polymer composition to be transported to the extruder head located at the extruder outlet, and the thermoplastic polymer material to be gradually melted (substeps ii-3) and ii-4)).

Substep ii-1) (or substep ii-2, respectively) may be performed at a pressure of not more than 5 bar, preferably not more than 3 bar, and preferably not more than 1.5 bar. In a particularly preferred embodiment, substep ii-1) (or substep ii-2, respectively) is performed at atmospheric pressure, namely at a pressure of about 1 bar.

Before substep ii-2) of introducing the thermoplastic polymer material into the extruder, said thermoplastic polymer material may be preheated to a temperature ranging from 40° C. to 100° C.

According to a preferred embodiment, substeps ii-1) and ii-2) are concomitant. In other words, the filler-charged dielectric liquid is fed simultaneously with the thermoplastic polymer material in solid form into the feed zone through the hopper of the extruder.

In substeps ii-3) and ii-4), the polymer composition is fed (continuously) from the feed zone to one or more intermediate zones of the screw allowing transport of the composition to the extruder head located at the extruder exit, and gradual melting of the polymer.

The intermediate zones are located between the feed zone and the extruder head.

The intermediate zones may comprise one or more heating zones, allowing the temperature in the extruder to be controlled.

The molten state (melt) is reached when the thermoplastic polymer material is heated to a temperature greater than or equal to its melting point.

According to a particularly preferred embodiment of the invention, substeps ii-3) and ii-4) are concomitant.

Substep ii-4) [or substep ii-3), respectively] may be performed at a temperature ranging from about 170° C. to about 240° C., and particularly preferably from about 180° C. to about 220° C.

Substep ii-4) [or substep ii-3), respectively] may be performed at a pressure ranging from 1 to 300 bar.

The filler-charged dielectric liquid and the thermoplastic polymer material may be placed in contact in the feed hopper or in the extruder, notably in the feed zone; and preferably in the feed hopper.

The placing of the filler-charged dielectric liquid in contact with the thermoplastic polymer material may be performed at a temperature ranging from about 15° C. to about 80° C., and preferably at ambient temperature.

In the present invention, the term “ambient temperature” means a temperature ranging from about 15 to about 35° C., and preferably ranging from about 20 to about 25° C.

The placing in contact of said filler-charged dielectric liquid and said thermoplastic polymer material is preferably performed at a pressure of not more than 5 bar, preferably not more than 3 bar, and preferably not more than 1.5 bar. In a particularly preferred embodiment, the placing in contact is performed at atmospheric pressure, namely at a pressure equal to about 1 bar.

Substep ii-3) or the placing in contact of the filler-charged dielectric liquid and the thermoplastic polymer material preferably does not include a step of impregnating the thermoplastic polymer material with the dielectric liquid. In other words, the dielectric liquid is not completely absorbed by the thermoplastic polymer material, notably before the thermoplastic polymer material is melted according to substep 4). The reason for this is that a conventional impregnation step is time-consuming and requires a minimum amount of dielectric liquid (about 10-15% relative to the total mass of the polymer composition).

According to a particularly preferred embodiment of the invention, the extruder comprises a barrier screw and/or a grooved barrel. The use of a specific barrel (i.e. grooved barrel) and/or a specific screw (i.e. barrier screw) makes it possible to obtain a homogeneous composition that is easy to extrude, while at the same time avoiding or limiting the formation of structural defects in the resulting thermoplastic electrically insulating layer.

On conclusion of step ii), the filler-charged dielectric liquid forms an intimate mixture with the thermoplastic polymer material.

The Polypropylene-Based Thermoplastic Polymer Material

The polypropylene-based thermoplastic polymer material may comprise a propylene homopolymer or copolymer P₁, and preferably a propylene copolymer P₁.

The propylene homopolymer P₁ preferably has an elastic modulus ranging from about 1250 to 1600 MPa.

In the present invention, the elastic modulus or Young's modulus of a polymer (known as the Tensile Modulus) is well known to those skilled in the art, and may be readily determined according to the standard ISO 527-1, -2 (2012). The standard ISO 527 has a first part, noted “ISO 527-1”, and a second part, noted “ISO 527-2” specifying the test conditions relating to the general principles of the first part of the standard ISO 527.

The propylene homopolymer P₁ may represent at least 10% by weight, and preferably from 15 to 30% by weight, relative to the total weight of the polypropylene-based thermoplastic polymer material.

As examples of propylene copolymers P₁, mention may be made of copolymers of propylene and olefin, the olefin being notably chosen from ethylene and an olefin α₁ other than propylene.

The ethylene or the olefin α₁ other than propylene of the propylene-olefin copolymer preferably represents not more than about 45 mol %, particularly preferably not more than about 40 mol %, and more particularly preferably not more than about 35 mol %, relative to the total number of moles of propylene-olefin copolymer.

The molar percentage of ethylene or olefin α₁ in the propylene copolymer P₁ may be determined by nuclear magnetic resonance (NMR), for example according to the method described in Masson et al., Int. J. Polymer Analysis & Characterization, 1996, volume 2, 379-393.

The olefin α₁ other than propylene may have the formula CH₂═CH—R¹, in which R¹ is a linear or branched alkyl group containing from 2 to 12 carbon atoms, notably chosen from the following olefins: 1-butene, 1-pentene, 4-methyl-1-pentene, 1-hexene, 1-octene, 1-decene, 1-dodecene, and a mixture thereof.

Propylene-ethylene copolymers are preferred as the propylene copolymer P₁.

The propylene copolymer P₁ may be a homophasic propylene copolymer or a heterophasic propylene copolymer, and preferably a heterophasic propylene copolymer.

In the invention, the homophasic propylene copolymer P₁ preferably has an elastic modulus ranging from about 600 to 1200 MPa, and particularly preferably ranging from about 800 to 1100 MPa.

Advantageously, the homophasic propylene copolymer P₁ is a statistical propylene copolymer P₁.

The ethylene or olefin α₁ other than propylene of the homophasic propylene copolymer P₁ preferably represents not more than about 20 mol %, particularly preferably not more than about 15 mol %, and more particularly preferably not more than about 10 mol %, relative to the total number of moles of the homophasic propylene copolymer P₁.

The ethylene or olefin α₁ other than propylene of the homophasic propylene copolymer P₁ may represent at least about 1 mol %, relative to the total number of moles of homophasic propylene copolymer P₁.

An example of a statistical propylene copolymer P₁ that may be mentioned is the product sold by the company Borealis under the reference Bormed® RB 845 MO or the product sold by the company Total Petrochemicals under the reference PPR3221.

The heterophasic (or heterophase) propylene copolymer P₁ may comprise a thermoplastic propylene phase and a thermoplastic elastomer phase of copolymer of ethylene and an olefin α₂.

The olefin α₂ of the thermoplastic elastomer phase of the heterophasic propylene copolymer P₁ may be propylene.

The thermoplastic elastomer phase of the heterophasic propylene copolymer P₁ may represent at least about 20% by weight, and preferably at least about 45% by weight, relative to the total weight of the heterophasic propylene copolymer P₁.

The heterophasic propylene copolymer P₁ preferably has an elastic modulus ranging from about 50 to about 1200 MPa, and particularly preferably: either an elastic modulus ranging from about 50 to about 550 MPa, and more particularly preferably ranging from about 50 to about 300 MPa; or an elastic modulus ranging from about 600 to about 1200 MPa, and more particularly preferably ranging from about 800 to about 1200 MPa.

As an example of a heterophasic propylene copolymer, mention may be made of the heterophasic propylene copolymer sold by the company LyondellBasell under the reference Adflex® Q 200 F, or the heterophasic copolymer sold by the company LyondellBasell under the reference Moplen EP® 2967.

The propylene homopolymer or copolymer P₁ may have a melting point of greater than about 110° C., preferably greater than about 130° C., particularly preferably greater than about 135° C., and more particularly preferably ranging from about 140 to about 170° C.

The propylene homopolymer or copolymer P₁ may have an enthalpy of fusion ranging from about 20 to 100 J/g.

Preferably, the propylene homopolymer P₁ has an enthalpy of fusion ranging from about 80 to 90 J/g.

The homophasic propylene copolymer P₁ preferably has an enthalpy of fusion ranging from about 40 to 90 J/g, and particularly preferably ranging from 50 to 85 J/g.

The heterophasic propylene copolymer P₁ preferably has an enthalpy of fusion ranging from about 20 to 50 J/g.

The propylene homopolymer or copolymer P₁ may have a melt flow index ranging from 0.5 to 3 g/10 min; notably determined at about 230° C. with a load of about 2.16 kg according to the standard ASTM D1238-00, or the standard ISO 1133.

The homophasic propylene copolymer P₁ preferably has a melt flow index ranging from 1.0 to 2.75 g/10 min, and more preferably ranging from 1.2 to 2.5 g/10 min; notably determined at about 230° C. with a load of about 2.16 kg according to the standard ASTM D1238-00, or the standard ISO 1133.

The heterophasic propylene copolymer P₁ may have a melt flow index ranging from about 0.5 to 3 g/10 min, and preferably ranging from about 0.6 to 1.2 g/10 min; notably determined at about 230° C. with a load of about 2.16 kg according to the standard ASTM D1238-00, or the standard ISO 1133.

The propylene homopolymer or copolymer P₁ may have a density ranging from about 0.81 to about 0.92 g/cm³; notably determined according to the standard ISO 1183A (at a temperature of 23° C.).

The propylene copolymer P₁ preferably has a density ranging from 0.85 to 0.91 g/cm 3 and particularly preferably ranging from 0.87 to 0.91 g/cm³; notably determined according to the standard ISO 1183A (at a temperature of 23° C.).

The polypropylene-based thermoplastic polymer material may comprise several different propylene copolymers P₁, notably two different propylene copolymers P₁, said propylene copolymers P₁ being as defined above.

In particular, the polypropylene-based thermoplastic polymer material may comprise a homophasic propylene copolymer (as a first propylene copolymer P₁) and a heterophasic propylene copolymer (as a second propylene copolymer P₁), or two different heterophasic propylene copolymers.

When the polypropylene-based thermoplastic polymer material comprises a homophasic propylene copolymer and a heterophasic propylene copolymer, said heterophasic propylene copolymer preferably has an elastic modulus ranging from about 50 to 300 MPa.

According to one embodiment of the invention, the two heterophasic propylene copolymers have a different elastic modulus. Preferably, the polypropylene-based thermoplastic polymer material comprises a first heterophasic propylene copolymer having an elastic modulus ranging from about 50 to about 550 MPa, and particularly preferably ranging from about 50 to about 300 MPa; and a second heterophasic propylene copolymer having an elastic modulus ranging from about 600 to about 1200 MPa, and more particularly preferably ranging from about 800 to about 1200 MPa.

Advantageously, the first and second heterophasic propylene copolymers have a melt flow index as defined in the invention.

These combinations of propylene copolymers P₁ may advantageously allow the mechanical properties of the electrically insulating layer to be improved. In particular, the combination affords optimized mechanical properties of the electrically insulating layer, notably in terms of elongation at break, and flexibility; and/or allows a more homogeneous electrically insulating layer to be formed, and notably favors the dispersion of the dielectric liquid in the polypropylene-based thermoplastic polymer material of said electrically insulating layer.

According to a preferred embodiment of the invention, the propylene copolymer P₁ or the propylene copolymers P₁ when more than one is present, represent at least about 50% by weight, preferably from about 55% to 90% by weight, and particularly preferably from about 60% to 85% by weight, relative to the total weight of the polypropylene-based thermoplastic polymer material.

The homophasic propylene copolymer P₁ may represent at least 20% by weight, and preferably from 25% to 70% by weight, relative to the total weight of the polypropylene-based thermoplastic polymer material.

The heterophasic propylene copolymer P₁ or the heterophasic propylene copolymers P₁ when more than one is present may represent from about 5% to 95% by weight, preferably from about 25% to 90% by weight, and particularly preferably from about 60% to 80% by weight, relative to the total weight of the polypropylene-based thermoplastic polymer material.

The polypropylene-based thermoplastic polymer material may also comprise an olefin homopolymer or copolymer P₂.

Said olefin homopolymer or copolymer P₂ is preferably different from said propylene homopolymer or copolymer P₁.

The olefin of the olefin copolymer P₂ may be chosen from ethylene and an olefin α3 having the formula CH₂═CH—R², in which R² is a linear or branched alkyl group containing from 1 to 12 carbon atoms.

The olefin α₃ is preferably chosen from the following olefins: propylene, 1-butene, isobutylene, 1-pentene, 4-methyl-1-pentene, 1-hexene, 1-octene, 1-decene, 1-dodecene, and a mixture thereof.

The olefin α₃ of the propylene, 1-hexene or 1-octene type is particularly preferred.

The combination of polymers P₁ and P₂ makes it possible to obtain a thermoplastic polymer material with good mechanical properties, notably in terms of elastic modulus, and good electrical properties.

The olefin homopolymer or copolymer P₂ is preferably an ethylene polymer.

The ethylene polymer preferably comprises at least about 80 mol % of ethylene, particularly preferably at least about 90 mol % of ethylene, and more particularly preferably at least about 95 mol % of ethylene, relative to the total number of moles of the ethylene polymer.

According to a preferred embodiment of the invention, the ethylene polymer is a low-density polyethylene, a linear low-density polyethylene, a medium-density polyethylene, or a high-density polyethylene, and preferably a high-density polyethylene; notably according to the standard ISO 1183A (at a temperature of 23° C.). The high-density polyethylene enables the thermal conductivity of the polymer composition to be further improved.

The ethylene polymer preferably has an elastic modulus of at least 400 MPa, and particularly preferably of at least 500 MPa.

In the present invention, the elastic modulus or Young's modulus of a polymer (known as the Tensile Modulus) is well known to those skilled in the art, and may be readily determined according to the standard ISO 527-1, -2 (2012). The standard ISO 527 has a first part, noted “ISO 527-1”, and a second part, noted “ISO 527-2” specifying the test conditions relating to the general principles of the first part of the standard ISO 527.

In the present invention, the term “low density” means having a density ranging from about 0.91 to about 0.925 g/cm³, said density being measured according to the standard ISO 1183A (at a temperature of 23° C.).

In the present invention, the term “medium density” means having a density ranging from about 0.926 to about 0.940 g/cm³, said density being measured according to the standard ISO 1183A (at a temperature of 23° C.).

In the present invention, the term “high density” means having a density ranging from 0.941 to 0.965 g/cm³, said density being measured according to the standard ISO 1183A (at a temperature of 23° C.).

According to a preferred embodiment of the invention, the olefin homopolymer or copolymer P₂ represents from about 5% to 50% by weight, and particularly preferably from about 10% to 40% by weight, relative to the total weight of the polypropylene-based thermoplastic polymer material.

According to a particularly preferred embodiment of the invention, the polypropylene-based thermoplastic polymer material comprises two propylene copolymers P₁ such as a homophasic propylene copolymer and a heterophasic propylene copolymer or two different heterophasic propylene copolymers; and an olefin homopolymer or copolymer P₂ such as an ethylene polymer. This combination of propylene copolymers P₁ and an olefin homopolymer or copolymer P₂ allows further improvement of the mechanical properties of the electrically insulating layer, while at the same time ensuring good thermal conductivity.

The thermoplastic polymer material of the polymer composition of the electrically insulating layer of the cable of the invention is preferably heterophasic (i.e. it comprises several phases). The presence of several phases generally results from the mixing of two different polyolefins, such as a mixture of different propylene polymers or a mixture of a propylene polymer and an ethylene polymer.

On conclusion of step ii), a polymer composition comprising at least said thermoplastic polymer material, said dielectric liquid, and said thermally conductive inorganic filler is obtained.

The polymer composition of the electrically insulating layer of the invention is a thermoplastic polymer composition. It is thus not crosslinkable.

In particular, the polymer composition does not comprise any crosslinking agents, silane couplers, peroxides and/or additives that enable crosslinking. The reason for this is that such agents degrade the polypropylene-based thermoplastic polymer material.

The polymer composition is preferably recyclable.

The polymer composition may comprise at least about 1% by weight, preferably at least about 2% by weight, particularly preferably at least about 5% by weight, and more particularly preferably at least about 10% by weight, of thermally conductive inorganic filler relative to the total weight of the polymer composition.

The polymer composition may comprise not more than about 50% by weight, particularly preferably not more than about 40% by weight, and more particularly preferably not more than about 30% by weight, of thermally conductive inorganic filler relative to the total weight of the polymer composition.

The polymer composition may typically comprise from about 0.01% to about 5% by weight, and preferably from about 0.1% to about 2% by weight of additives, relative to the total weight of the polypropylene-based thermoplastic polymer material.

The dielectric liquid represents from about 1% to about 20% by weight, preferably from about 2% to about 15% by weight, and particularly preferably from about 3% to about 12% by weight, relative to the total weight of the polymer composition.

The polypropylene-based thermoplastic polymer material may represent at least about 50% by weight, preferably at least about 70% by weight, and particularly preferably at least about 80% by weight, relative to the total weight of the polymer composition.

Step iii)

On conclusion of step ii), a homogeneous polymer composition is obtained, which may then be extruded around the elongated electrically conductive element according to step iii), to obtain an (extruded) electrically insulating layer surrounding said elongated electrically conductive element.

Step iii) may be performed using techniques that are well known to those skilled in the art, for example using an extruder.

When step ii) is performed using an extruder, step iii) consists in recovering the polymer composition formed in one or more intermediate zones of the extruder and fed to the head of the extruder for application around the elongated electrically conductive element.

In step iii), the composition comprising the thermoplastic polymer material in the molten state and the filler-charged dielectric liquid is notably passed under pressure through a die.

During step iii), the polymer composition leaving the extruder is said to be “non-crosslinked”, the processing temperature and time in the extruder being accordingly optimized.

At the extruder outlet, an extruded layer is thus obtained around said electrically conductive element, which may or may not be in direct physical contact with said elongated electrically conductive element.

The process of the invention preferably does not involve a step of crosslinking the layer obtained in step iii). The reason for this is that propylene polymers degrade under the action of crosslinking and/or in the presence of crosslinking agents such as peroxides.

The electrically insulating layer and/or the semiconductive layer(s) of the electric cable of the invention may be obtained by successive extrusion or by coextrusion.

The various compositions may be extruded one after the other to successively surround the elongated electrically conductive element, and thus to form the various layers of the electric cable of the invention.

Alternatively, they may be extruded concomitantly by coextrusion using a single extruder head, coextrusion being a process that is well known to those skilled in the art.

During step iii), the temperature within the extrusion device is preferably higher than the melting point of the predominant polymer or the polymer with the highest melting point, among the polymers used in the composition to be implemented.

This step iii) may be performed at a temperature ranging from about 180° C. to about 240° C., and preferably ranging from about 190° C. to about 220° C.

The Electrically Insulating Layer

The electrically insulating layer of the cable of the invention is a non-crosslinked layer, in other words a thermoplastic layer.

In the invention, the term “non-crosslinked layer” or “thermoplastic layer” means a layer with a gel content according to the standard ASTM D2765-01 (xylene extraction) of not more than about 30%, preferably not more than about 20%, particularly preferably not more than about 10%, more particularly preferably not more than 5%, and even more particularly preferably 0%.

In one embodiment of the invention, the preferably non-crosslinked electrically insulating layer has a thermal conductivity of at least 0.30 W/m·K at 40° C., preferably at least 0.31 W/m·K at 40° C., particularly preferably at least 0.32 W/m. K at 40° C., more particularly preferably at least 0.33 W/m·K at 40° C., even more particularly preferably at least 0.34 W/m·K at 40° C., and even more particularly preferably at least 0.35 W/m·K at 40° C.

In a particular embodiment, the preferably non-crosslinked electrically insulating layer has a tensile strength (TS) of at least about 8.5 MPa, preferably at least about 10 MPa, and particularly preferably at least about 15 MPa, before aging (according to the standard CEI 20-86).

In a particular embodiment, the preferably non-crosslinked electrically insulating layer has an elongation at break (EB) of at least about 250%, preferably at least about 300%, and particularly preferably at least about 350%, before aging (according to the standard CEI 20-86).

In a particular embodiment, the preferably non-crosslinked electrically insulating layer has a tensile strength (TS) of at least about 8.5 MPa, preferably at least about 10 MPa, and particularly preferably at least about 15 MPa, after aging (according to the standard CEI 20-86).

In a particular embodiment, the preferably non-crosslinked electrically insulating layer has an elongation at break (EB) of at least about 250%, preferably at least about 300%, and particularly preferably at least about 350%, after aging (according to the standard CEI 20-86).

The tensile strength (TS) and elongation at break (EB) (before or after aging) may be determined according to the standard NF EN 60811-1-1, notably using a machine sold under the reference 3345 by the company Instron.

The aging is generally performed at 135° C. for 240 hours (or 10 days).

The electrically insulating layer of the cable of the invention is preferably a recyclable layer.

The electrically insulating layer of the invention may be a layer that is extruded, notably via processes that are well known to those skilled in the art.

The electrically insulating layer has a thickness that is variable as a function of the type of cable envisaged. In particular, when the cable in accordance with the invention is a medium-voltage cable, the thickness of the electrically insulating layer is typically from about 4 to about 5.5 mm, and more particularly about 4.5 mm. The abovementioned thicknesses depend on the size of the elongated electrically conductive element.

In the present invention, the term “electrically insulating layer” means a layer having an electrical conductivity which may be not more than 1×10⁻⁸ S/m (siemens per metre), preferably not more than 1×10⁻⁹ S/m, and particularly preferably not more than 1×10⁻¹⁰ S/m, measured at 25° C. in DC.

The electrically insulating layer of the invention may comprise at least the polypropylene-based thermoplastic polymer material, at least the thermally conductive inorganic filler, and the dielectric liquid, the abovementioned ingredients being as defined in the invention.

The proportions of the various ingredients in the electrically insulating layer may be identical to those as described in the invention for these same ingredients in the polymer composition.

The cable of the invention relates more particularly to the field of electric cables operating in direct current (DC) or alternating current (AC).

The Cable

The electrically insulating layer of the invention may surround the elongated electrically conductive element.

The elongated electrically conductive element is preferably positioned at the center of the cable.

The elongated electrically conductive element may be a single-body conductor, for instance a metal wire, or a multi-body conductor such as a plurality of twisted or untwisted metal wires.

The elongated electrically conductive element may be made of aluminum, aluminum alloy, copper, copper alloy, or a combination thereof.

According to a preferred embodiment of the invention, the electric cable comprises:
at least one semiconductive layer surrounding the elongated electrically conductive element, and
an electrically insulating layer as defined in the invention.

More particularly, the electrically insulating layer has a lower electrical conductivity than that of the semiconductive layer. More particularly, the electrical conductivity of the semiconductive layer may be at least 10 times greater than the electrical conductivity of the electrically insulating layer, preferably at least 100 times greater than the electrical conductivity of the electrically insulating layer, and particularly preferably at least 1000 times greater than the electrical conductivity of the electrically insulating layer.

The semiconductive layer may surround the electrically insulating layer. The semiconductive layer may then be an outer semiconductive layer.

The electrically insulating layer may surround the semiconductive layer. The semiconductive layer may then be an inner semiconductive layer.

The semiconductive layer is preferably an inner semiconductive layer.

The electric cable of the invention may also comprise another semiconductive layer.

Thus, in this embodiment, the cable of the invention may comprise:
at least one elongated electrically conductive element, preferably positioned at the center of the cable,
a first semiconductive layer surrounding the elongated electrically conductive element,
an electrically insulating layer surrounding the first semiconductive layer, and
a second semiconductive layer surrounding the electrically insulating layer, the electrically insulating layer being as defined in the invention.

In the present invention, the term “semiconductive layer” means a layer whose electrical conductivity may be strictly greater than 1×10⁻⁸ S/m (siemens per metre), preferably at least 1×10⁻³ S/m, and may preferably be less than 1×10³ S/m, measured at 25° C. in DC.

In a particular embodiment, the first semiconductive layer, the electrically insulating layer and the second semiconductive layer constitute a three-layer insulation. In other words, the electrically insulating layer is in direct physical contact with the first semiconductive layer, and the second semiconductive layer is in direct physical contact with the electrically insulating layer.

The first semiconductive layer (or, respectively, the second semiconductive layer) is preferably obtained from a polymer composition comprising at least one polypropylene-based thermoplastic polymer material as defined in the invention, and optionally at least one electrically conductive filler as defined in the invention.

The electrically conductive filler preferably represents an amount sufficient for the layer to be semiconductive.

Preferably, the polymer composition may comprise at least about 6% by weight of electrically conductive filler, preferably at least about 10% by weight of electrically conductive filler, preferentially at least about 15% by weight of electrically conductive filler, and even more preferentially at least about 25% by weight of electrically conductive filler, relative to the total weight of the polymer composition.

The polymer composition may comprise not more than about 45% by weight of electrically conductive filler, and preferably not more than about 40% by weight of electrically conductive filler, relative to the total weight of the polymer composition.

The electrically conductive filler may be carbon black.

The first semiconductive layer (or, respectively, the second semiconductive layer) is preferably a thermoplastic layer or a non-crosslinked layer.

The cable may also comprise an outer protective sheath surrounding the electrically insulating layer (or the second semiconductive layer, if present).

The outer protective sheath may be in direct physical contact with the electrically insulating layer (or the second semiconductive layer, if present).

The outer protective sheath may be an electrically insulating sheath.

The electric cable may also comprise an electrical shield (e.g. metallic) surrounding the second semiconductive layer. In this case, the electrically insulating sheath surrounds said electrical shield and the electrical shield is between the electrically insulating sheath and the second semiconductive layer.

This metallic shield may be a “wire shield” composed of a set of copper or aluminum conductors arranged around and along the second semiconductive layer, a “ribbon” shield composed of one or more conductive copper or aluminum metal ribbons which may be laid in a helix around the second semiconductive layer, or a conductive aluminum metal ribbon laid longitudinally around the second semiconductive layer and rendered leaktight by means of adhesive in the overlapping areas of parts of said ribbon, or a “leaktight” shield of the metal tube type, possibly composed of lead or lead alloy and surrounding the second semiconductive layer. This last type of shield can notably act as a barrier to moisture, which has a tendency to penetrate the electric cable in the radial direction.

The metal shield of the electric cable of the invention may comprise a “wire shield” and a “leaktight shield” or a “wire shield” and a “ribbon shield”.

All the types of metal shield may act as earthing for the electric cable and may thus transport fault currents, for example in the case of short-circuiting in the network concerned.

Other layers, such as layers which swell in the presence of moisture, may be added between the second semiconductive layer and the metal shield, these layers providing the longitudinal leaktightness to water of the electric cable.

### BRIEF DESCRIPTION OF THE DRAWINGS

FIG. 1 illustrates a device for performing a process in accordance with the invention.

For the sake of clarity, only the elements that are essential for the understanding of the invention have been represented schematically, and are not to scale.

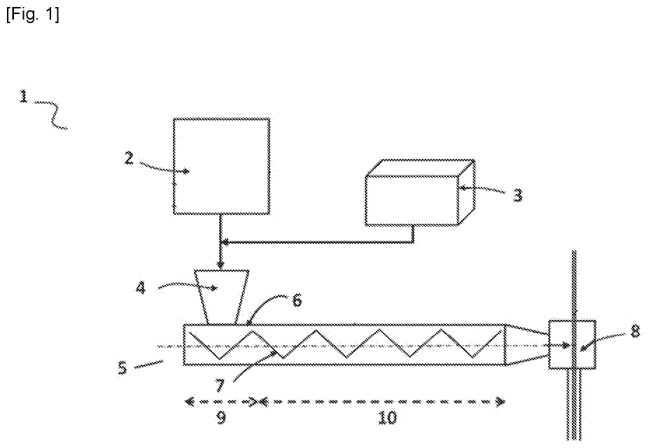

In FIG. 1, the device 1 comprises a container 2 which may be fed with granules of a thermoplastic polymer material chosen from a homopolymer and a copolymer of propylene, a container 3 which may be fed with a filler-charged dielectric liquid (i.e. dielectric liquid+thermally conductive inorganic filler), a feed hopper 4 which may be fed at ambient temperature with the granules of the thermoplastic polymer material contained in the container 2 and with the filler-charged dielectric liquid contained in the container 3, and an extruder 5 comprising a grooved barrel 6 and/or a barrier screw 7, and also an extruder head 8. The granules of the thermoplastic polymer material and the filler-charged dielectric liquid are introduced via the feed hopper 4 into a feed zone 9 of the screw according to step i), and then fed from the feed zone 9 to one or more intermediate zones 10 allowing the polymer composition to be transported to the extruder head 8 located at the outlet of the extruder 5 and the gradual melting of the thermoplastic polymer material, said intermediate zones 10 being located between the feed zone 9 and the extruder head 8. Finally, at the extruder head 8, the polymer composition is applied around an elongated electrically conductive element.

### EXAMPLE

Dielectric Liquids

A filler-charged dielectric liquid L1 comprising 50% by weight of a mineral oil BNS28 from Nynas, and 50% by weight of an alumina Timal 17 from Alteo was prepared by mixing the oil and alumina at ambient temperature in a mixer sold under the trade name Speedmixer DAC 400 FV at a rotational speed ranging from 1800 rpm to 2250 rpm. The mixing causes the oil to heat up. The alumina used has a D50 of about 400 nm, and a specific surface area of about 8 m²/g.

Thermal conductivity tests were performed on the filler-charged dielectric liquid obtained, and for comparative purposes on the mineral oil without alumina (also called the uncharged dielectric liquid L0).

The table below shows the various thermal conductivities obtained. The thermal conductivity was measured according to the well known Transient Plane Source or TPS method using a machine sold under the reference Hot Disk TPS 2500S by the company Thermoconcept.

TABLE 1

| | Thermal | Thermal |
|---|---|---|
| | conductivity at | conductivity at |
| Dielectric liquid | 28° C. in [W/(m · K)] | 71° C. in [W/(m · K)] |
| Filler-charged dielectric | 0.308 | 0.307 |
| liquid L1 | | |
| Uncharged dielectric | 0.129 | 0.130 |
| liquid L0 (*) | | |

(*) outside the invention

Polymer Compositions

A layer in accordance with the invention, i.e. obtained from a polymer composition C1 comprising at least one polypropylene-based thermoplastic polymer material, at least one dielectric liquid, and at least one thermally conductive inorganic filler was prepared according to a process in accordance with the invention (with prior preparation of a filler-charged dielectric liquid). For comparative purposes, a layer not in accordance with the invention, i.e. obtained from a polymer composition C0 comprising at least one polypropylene-based thermoplastic polymer material, at least one dielectric liquid, and at least one thermally conductive inorganic filler, was prepared according to a process not in accordance with the invention (no prior preparation of a filler-charged dielectric liquid).

Table 2 below collates the amounts of the compounds present in the polymer composition in accordance with the invention which are expressed as weight percentages, relative to the total weight of the polymer composition.

TABLE 2

| Ingredients of the | Composition | Composition |
|---|---|---|
| polymer composition | C1 | C0 (*) |
| Heterophasic propylene copolymer | 31.80 | 31.80 |
| Statistical propylene copolymer | 31.80 | 31.80 |
| High-density polyethylene | 23.57 | 23.57 |
| Thermally conductive inorganic | 6.6 | 6.6 |
| filler: Timal 17 alumina | | |
| Dielectric liquid | 5.23 | 5.23 |
| Antioxidant | 1 | 1 |

(*) outside the invention

The origin of the compounds in Table 1 is as follows:
statistical propylene copolymer sold by the company Total Petrochemicals under the reference PPR3221;
heterophasic propylene copolymer sold by the company Basell Polyolefins under the reference Adflex® Q 200 F;
high-density polyethylene sold under the trade name Eltex® A4009 MFN1325 by the company Ineos and whose density is 0.960 g/cm³ according to the standard ISO 1183A at a temperature of 23° C. (MFI=0.9);
antioxidant sold by the company Ciba under the reference Irganox® B 225 comprising an equimolar mixture of Irgafos® 168 and Irganox® 1010; and
a dielectric liquid comprising 95.6% by weight of an oil sold by the company Nynas under the reference BNS 28, and 4.4% by weight of benzophenone.

Non-Crosslinked Layers

The following constituents: mineral oil, antioxidant and benzophenone of the polymer compositions C0 and C1 listed in Table 2, are measured out and mixed with stirring at about 75° C., so as to form a dielectric liquid.

For the preparation of the layer relating to composition C1, the dielectric liquid thus obtained is then mixed with the thermally conductive inorganic filler using a mixer sold under the trade name Speedmixer DAC 400 FV at a rotational speed ranging from 1800 rpm to 2250 rpm and at ambient temperature, to form a filler-charged dielectric liquid.

The filler-charged dielectric liquid is then mixed with the following constituents: heterophasic propylene copolymer, statistical propylene copolymer, high-density polyethylene of the polymer composition referenced in Table 2, in a container. The resulting mixture is then homogenized using a Berstorff twin-screw extruder at a temperature of about 145 to 180° C. and then melted at about 200° C. (screw speed: 80 rpm).

The homogenized and melted mixture is then formed into granules.

The granules are then hot-pressed to form a layer in the form of a plate.

The polymer composition C1 was thus prepared in the form of an 8 mm thick layer for performing thermal conductivity measurements.

For the preparation of the layer relating to composition C0, the dielectric liquid was not premixed with the thermally conductive inorganic filler, prior to addition of the thermoplastic polymer material. In other words, the resulting dielectric liquid is then mixed with the following constituents: heterophasic propylene copolymer, statistical propylene copolymer, high-density polyethylene of the composition C0 referenced in Table 2, in a container. Then, the resulting mixture and the inorganic filler is homogenized using a Berstorff twin-screw extruder at a temperature of about 145 to 180° C. and then melted at about 200° C. (screw speed: 80 rpm). The homogenized and melted mixture is then formed into granules. The granules are then hot-pressed to form a layer in the form of a plate.

The polymer composition C0 was thus prepared in the form of an 8 mm thick layer for performing thermal conductivity measurements.

The results are given in Table 3 below:

TABLE 3

| | Layer obtained with | Layer obtained with |
|---|---|---|
| | polymer composition | polymer composition |
| Properties | C1 | C0 (*) |
| Thermal conductivity at | 0.271 | 0.250 |
| 40° C. (W/m · K) | | |
| Thermal conductivity at | 0.265 | 0.250 |
| 70° C. (W/m · K) | | |

(*) outside the invention

All these results show that the prior preparation of a filler-charged dielectric liquid before placing in contact with the thermoplastic polymer material according to the process of the invention improves the thermal conductivity properties of the cable layer.

1. A process for manufacturing an electric cable having at least one elongated electrically conductive element and at least one electrically insulating layer obtained from a polymer composition having at least one polypropylene-based thermoplastic polymer material, at least one dielectric liquid, and at least one thermally conductive inorganic filler, said process comprising at least the following steps:
i) mixing the dielectric liquid with the thermally conductive inorganic filler, to form a filler-charged dielectric liquid,
ii) mixing the filler-charged dielectric liquid with the thermoplastic polymer material to form a polymer composition, and
iii) extruding the polymer composition around the elongated electrically conductive element.

2. The process as claimed in claim 1, wherein step i) is performed at a temperature ranging from 0° C. to 100° C.

3. The process as claimed in claim 1, wherein step i) is performed with a turbomixer, a tubular continuous mixing device, a planetary mixer, and/or an ultrasonic device.

4. The process as claimed in claim 1, wherein, on conclusion of step i), the thermally conductive inorganic filler represents from 10% to 75% by weight, relative to the total weight of the filler-charged dielectric liquid.

5. The process as claimed in claim 1, wherein the thermally conductive inorganic filler is chosen from silicates, boron nitride, carbonates, metal oxides, and a mixture thereof.

6. The process as claimed in claim 1, wherein the thermally conductive inorganic filler is in the form of nanometric particles.

7. The process as claimed in claim 1, wherein step ii) is performed using an extruder or an internal mixer.

8. The process as claimed in claim 1, wherein step ii) is performed at a temperature ranging from 170° C. to 240° C.

9. The process as claimed in claim 1, wherein, in step ii), the polypropylene-based thermoplastic polymer material is used in an amount such that it represents from 75% to 97% by weight relative to the total weight of the polymer composition.

10. The process as claimed in claim 1, wherein the polypropylene-based thermoplastic polymer material comprises a propylene copolymer P₁ chosen from a homophasic propylene copolymer and a heterophasic propylene copolymer.

11. The process as claimed in claim 1, wherein step ii) is performed according to the following substeps:
ii-1) introducing the filler-charged dielectric liquid into an extruder by means of a feed hopper,
ii-2) introducing the thermoplastic polymer material, notably in the form of granules, into the extruder by means of the feed hopper,
ii-3) mixing the filler-charged dielectric liquid and the thermoplastic polymer material in the extruder so as to form the polymer composition, and
ii-4) melting the thermoplastic polymer material.

12. The process as claimed in claim 11, wherein substeps ii-1) and ii-2) are performed at a pressure of not more than 5 bar.

13. The process as claimed in claim 11, wherein substeps ii-3) and ii-4) are concomitant.

14. The process as claimed in claim 11, wherein the filler-charged dielectric liquid and the thermoplastic polymer material are placed in contact in the feed hopper or in the extruder.

15. The process as claimed in claim 14, wherein the placing of the filler-charged dielectric liquid in contact with the thermoplastic polymer material is performed at a temperature ranging from 15 to 80° C. and at a pressure of not more than 5 bar.
